(19) United States
(12) Patent Application Publication
(10) Pub. No.: US 2026/0146646 A1
(43) Pub. Date: May 28, 2026

(54) SLIDE RAIL ASSEMBLY

(71) Applicants: KING SLIDE WORKS CO., LTD., Kaohsiung City (TW); KING SLIDE TECHNOLOGY CO., LTD., Kaohsiung City (TW)

(72) Inventors: Ken-Ching Chen, Kaohsiung City (TW); Shun-Ho Yang, Kaohsiung City (TW); Kai-Wen Yu, Kaohsiung City (TW); Chun-Chiang Wang, Kaohsiung City (TW)

(73) Assignees: KING SLIDE WORKS CO., LTD., Kaohsiung City (TW); KING SLIDE TECHNOLOGY CO., LTD., Kaohsiung City (TW)

(21) Appl. No.: 19/248,444

(22) Filed: Jun. 24, 2025

(30) Foreign Application Priority Data
Nov. 28, 2024 (TW) 113146398

(51) Int. Cl. F16C 29/02

(52) U.S. Cl. CPC F16C 29/02

(57) ABSTRACT

A slide rail assembly is provided and includes a first rail, a second rail, an aid-sliding device, a resilient member and an auxiliary member. A predetermined structure is arranged on the first rail. The second rail is displaceable relative to the first rail. The aid-sliding device is movably mounted between the first rail and the second rail. The resilient member is arranged on the aid-sliding device and includes a predetermined feature. The auxiliary member is arranged on the second rail. During a process that the second rail is displaced relative to the first rail from an extended position in an opening direction for a detachment of the second rail in the opening direction, the auxiliary member contacts with the predetermined feature of the resilient member to drive the aid-sliding device in the opening direction to reach a predetermined position where the aid-sliding device engages with the predetermined structure.

### BACKGROUND OF THE INVENTION

### 1. FIELD OF THE INVENTION

The present invention relates to a slide rail product, and more specifically, to a slide rail assembly with a first rail, a second rail, an aid-sliding device and a retaining mechanism configured to retain the aid-sliding device during a detachment of the second rail relative to the first rail in an opening direction.

### 2. DESCRIPTION OF THE PRIOR ART

In U.S. Patent No. 9,980,566 B2, it discloses a slide rail assembly including a first rail, a second rail, a blocking base, a ball retainer and a blocking member. The blocking base is disposed on the first rail. The ball retainer is configured to facilitate a relative movement of the first rail and the second rail. The blocking member is arranged on the second rail. When the second rail is displaced relative to the first rail in an opening direction, the blocking member always forcibly drives the ball retainer until an engaging feature of the ball retainer engages with a resilient arm of the blocking base to retain the ball retainer at a predetermined position. However, an undesired frictional force may be generated between the second rail and the ball retainer retained at the predetermined position, which results in an unsmooth displacement of the second rail or a carried object on the second rail in either the opening direction or a retracting direction.

Furthermore, there is another slide rail assembly with a ball retainer which is configured not to be forcibly driven to be retained at a predetermined position when a second rail is displaced relative to a first rail in an opening direction. However, when the second rail is reinserted into a channel of the first rail from outside and the ball retainer is not retained at the predetermined position, the slide rail assembly fails to provide adequate support for the second rail with rolling balls of the ball retainer, thereby resulting in difficulty in insertion of the second rail.

Accordingly, in order to meet various requirements, it becomes an important topic to provide a different slide rail product.

### SUMMARY OF THE INVENTION

It is an objective of the present invention to provide a slide rail assembly with a first rail, a second rail, an aid-sliding device and a retaining mechanism configured to retain the aid-sliding device during a detachment of the second rail relative to the first rail in an opening direction.

According to an aspect of the present invention a slide rail assembly includes a first rail, a second rail, an aid-sliding device, a resilient member and an auxiliary member. A predetermined structure is arranged on the first rail. The second rail is displaceable relative to the first rail. The aid-sliding device is movably mounted between the first rail and the second rail. The resilient member is arranged on the aid-sliding device. The resilient member includes a predetermined feature. The auxiliary member is arranged on the second rail. During a process that the second rail is displaced relative to the first rail to an extended position in an opening direction, the auxiliary member does not contact with the predetermined feature of the resilient member. During a process that the second rail is displaced relative to the first rail from the extended position in the opening direction for a detachment of the second rail in the opening direction, the auxiliary member contacts with the predetermined feature of the resilient member to drive the aid-sliding device in the opening direction to reach a predetermined position where the aid-sliding device engages with the predetermined structure.

According to another aspect of the present invention, a slide rail assembly includes a first rail, a second rail, an aid-sliding device, a resilient member, an auxiliary member, a first working member and a first releasing member. The first rail includes a channel. A first predetermined feature and a blocking portion are located inside the channel. The second rail is displaceable relative to the first rail. The aid-sliding device is movably mounted between the first rail and the second rail. The resilient member is arranged on the aid-sliding device. The resilient member includes a second predetermined feature. The auxiliary member is arranged on the second rail. The first working member is movably mounted on the second rail. When the second rail is located at an extended position relative to the first rail, the first working member blocks an end of the blocking portion for preventing the second rail from displacing away from the extended position in an opening direction. The first releasing member is configured to operate the first working member to prevent the first working member from blocking the end of the blocking portion for allowing the second rail to displace away from the extended position in the opening direction. During a process that the second rail is displaced relative to the first rail away from the extended position in the opening direction for a detachment of the second rail from the channel of the first rail in the opening direction, the auxiliary member contacts with the second predetermined feature of the resilient member to drive the aid-sliding device in the opening direction to reach a predetermined position. The resilient member is switchable between a first state and a second state. The resilient member accumulates a resilient force when the resilient member is in the first state. When the aid-sliding device is located at the predetermined position, the second predetermined feature of the resilient member is located at a position corresponding to the first predetermined feature, such that the resilient member releases a resilient force to resiliently switch the resilient member from the first state to the second state in order to prevent the auxiliary member from contacting with the second predetermined feature of the resilient member for allowing the detachment of the second rail from the channel of the first rail in the opening direction.

In summary, the aid-sliding device can be driven to a predetermined position during the process that the second rail is displaced relative to the first rail from the extended position in the opening direction for the detachment of the second rail in the opening direction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a slide rail assembly according to an embodiment of the present invention.

FIG. 2 is an exploded diagram of the slide rail assembly according to the embodiment of the present invention.

FIG. 3 is a diagram of the slide rail assembly in a retracted state according to the embodiment of the present invention.

FIG. 4 is a diagram of the slide rail assembly in which a second rail is located at an extended position and in a locked state according to the embodiment of the present invention.

FIG. 5 is a diagram of the slide rail assembly in which the second rail is located at the extended position and in an unlocked state according to the embodiment of the present invention.

FIG. 6 is a diagram of the slide rail assembly in which the second rail is displaced relative to the first rail over the extended position in an opening direction according to the embodiment of the present invention.

FIG. 7 is a diagram of the slide rail assembly in which the second rail is detached from the first rail in the opening direction according to the embodiment of the present invention.

### DETAILED DESCRIPTION

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “left”, “right”, “front”, “back”, etc., is used with reference to the orientation of the Figure(s) being described. The components of the present invention can be positioned in a number of different orientations. As such, the directional terminology is used for purposes of illustration and is in no way limiting. Accordingly, the drawings and descriptions will be regarded as illustrative in nature and not as restrictive. Also, if not specified, the term “connect” is intended to mean either an indirect or direct mechanical connection. Thus, if a first device is connected to a second device, that connection may be through a direct mechanical connection, or through an indirect mechanical connection via other devices and connections.

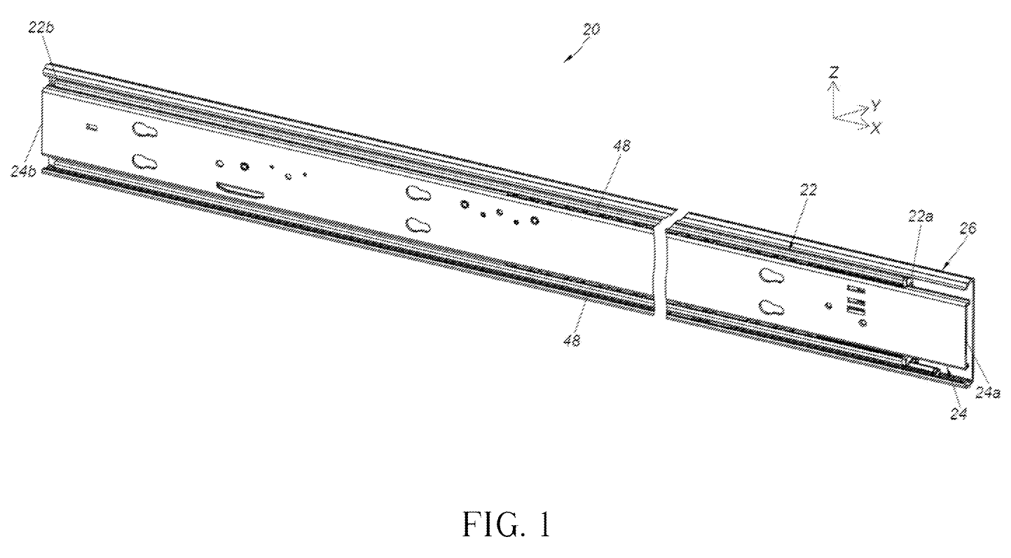

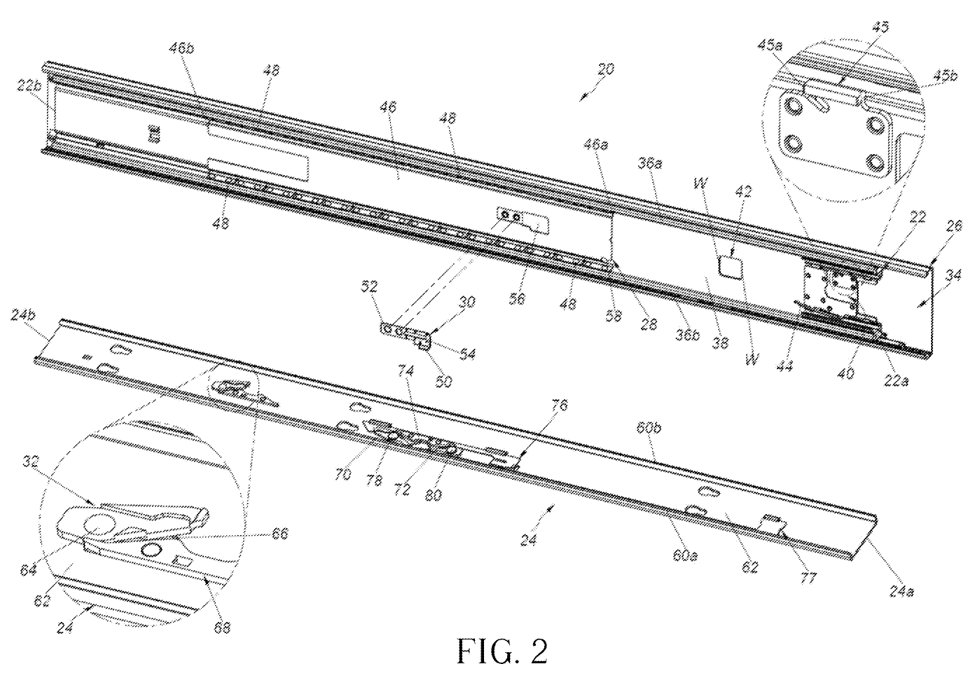

As shown in FIG. 1 to FIG. 3, a slide rail assembly 20 includes a first rail 22 and a second rail 24. Preferably, the slide rail assembly 20 further includes a third rail 26, and the first rail 22, the second rail 24 and the third rail 26 are displaceable relative to one another in a longitudinal direction. In this embodiment, by way of example, the longitudinal direction can be defined by a length direction or a displacing direction of a slide rail, e.g., the first rail 22, the second rail 24 or the third rail 26, and parallel to an X axis. A transverse direction can be defined by a lateral direction or a width direction of the slide rail, e.g., the first rail 22, the second rail 24 or the third rail 26, and parallel to a Y axis. A vertical direction can be defined by a height direction of the slide rail, e.g., the first rail 22, the second rail 24 or the third rail 26, and parallel to a Z axis. In this embodiment, by way of example, the first rail 22, the second rail 24 and the third rail 26 can be a middle rail, an inner rail and an outer rail, respectively, i.e., the first rail 22 can be movably mounted between the third rail 26 and the second rail 24. Besides, the slide rail assembly 20 further includes an aid-sliding device 28, a resilient member 30 and an auxiliary member 32.

The third rail 26 includes a predetermined channel 34 configured to at least partially receive the first rail 22. The first rail 22 includes a first end 22a and a second end 22b opposite to the first end 22a. In this embodiment, by way of example, the first end 22a and the second end 22b of the first rail 22 can be a front end and a rear end of the first rail 22, respectively. However, the present invention is not limited to this embodiment. The first rail 22 includes a first wall 36a, a second wall 36b and a longitudinal wall 38 connected between the first wall 36a and the second wall 36b of the first rail 22. The first wall 36a, the second wall 36b and the longitudinal wall 38 of the first rail 22 cooperatively define a channel 40 of the first rail 22 configured to at least partially receive the second rail 24. A first predetermined feature 42 and a predetermined structure 44 are arranged on the longitudinal wall 38 of the first rail 22 and located inside the channel 40 of the first rail 22. Preferably, in this embodiment, the first predetermined feature 42 can be a space, such as an opening, which is defined by a plurality of walls W cooperatively, and the predetermined structure 44 can be a resilient arm. However, the present invention is not limited to this embodiment. Preferably, a blocking portion 45 is further arranged on the first rail 22 and located inside the channel 40. For example, the blocking portion 45 can be a protruding portion protruding from the longitudinal wall 38 of the first rail 22 in the transverse direction and having a first end 45a and a second end 45b opposite to the first end 45a. Furthermore, the blocking portion 45 and the predetermined structure 44 are located adjacent to the first end 22a of the first rail 22.

The second rail 24 is movably mounted inside the channel 40 of the first rail 22 and can be detached from the channel 40 of the first rail 22. The second rail 24 includes a first end 24a and a second end 24b opposite to the first end 24a. In this embodiment, by way of example, the first end 24a and the second end 24b of the second rail 24 can be a front end and a rear end of the second rail 24, respectively. However, the present invention is not limited to this embodiment. The second rail 24 includes a first wall 60a, a second wall 60b and a longitudinal wall 62 connected between the first wall 60a and the second wall 60b of the second rail 24.

The aid-sliding device 28 is movably mounted between the first rail 22 and the second rail 24. Preferably, the aid-sliding device 28 includes a main body 46 and a plurality of rolling members 48, such as rolling balls, which are arranged on the main body 46 and configured to be rotatably abutted between the first wall 36a of the first rail 22 and the first wall 60a of the second rail 24 and between the second wall 36b of the first rail 22 and the second wall 60b of the second rail 24, so as to ensure a smooth displacement of the second rail 24 relative to the first rail 22.

The resilient member 30 is arranged on the aid-sliding device 28 and includes a second predetermined feature 50. Preferably, the resilient member 30 further includes a connecting portion 52 and a resilient portion 54. The connecting portion 52 is connected, e.g., fixedly connected, to the main body 46 of the aid-sliding device 28. The resilient portion 54 extends from the connecting portion 52, and the second predetermined feature 50 is arranged on the resilient portion 54. Preferably, in this embodiment, the second predetermined feature 50 can be a protruding section protruding from the resilient portion 54 in the transverse direction. However, the present invention is not limited to this embodiment. Preferably, the main body 46 of the aid-sliding device 28 includes a predetermined through hole 56. The resilient portion 54 of the resilient member 30 is located at a position corresponding to the predetermined through hole 56, thereby enabling the resilient portion 54 to cooperate with the first predetermined feature 42. Preferably, the main body 46 of the aid-sliding device 28 further includes an engaging feature 58, such as an engaging hook, which is configured to cooperate with the predetermined structure 44. Preferably, in this embodiment, by way of example, a first end 46a and a second end 46b of the main body 46 can be a front end and a rear end of the main body 46, respectively, and the engaging feature 58 can be located adjacent to the first end 46a of the main body 46.

The auxiliary member 32 is arranged on the second rail 24. In this embodiment, by way of example, the auxiliary member 32 can be mounted on the longitudinal wall 62 of the second rail 24 by a shaft member 64. However, the present invention is not limited to this embodiment. Preferably, the slide rail assembly 20 further includes a resilient feature 66 configured to provide a predetermined resilient force to the auxiliary member 32 for retaining the auxiliary member 32 in a predetermined state. For example, the resilient feature 66 can be a cable or wire having a specific shape, a resilient clip, or a resilient spring. However, the present invention is not limited thereto. Preferably, the slide rail assembly 20 further includes a base 68 arranged on the longitudinal wall 62 of the second rail 24 and configured to support the auxiliary member 32 and the resilient feature 66.

Preferably, the slide rail assembly 20 further includes a first working member 70, a second working member 72, at least one resilient structure 74, a first releasing member 76 and a second releasing member 77. The first working member 70 and the second working member 72 are movably mounted on the second rail 24. In this embodiment, by way of example, the first working member 70 and the second working member 72 can be pivotally connected to the longitudinal wall 62 of the second rail 24 by a first shaft portion 78 and a second shaft portion 80, respectively. The resilient structure 74 is configured to provide a resilient force to the first working member 70 and the second working member 72. For example, the resilient structure 74 can be a cable or wire having a specific shape, a resilient clip, or a resilient spring. However, the present invention is not limited thereto. Preferably, the first releasing member 76 and the second releasing member 77 are configured to operate the first working member 70 and the second working member 72, respectively.

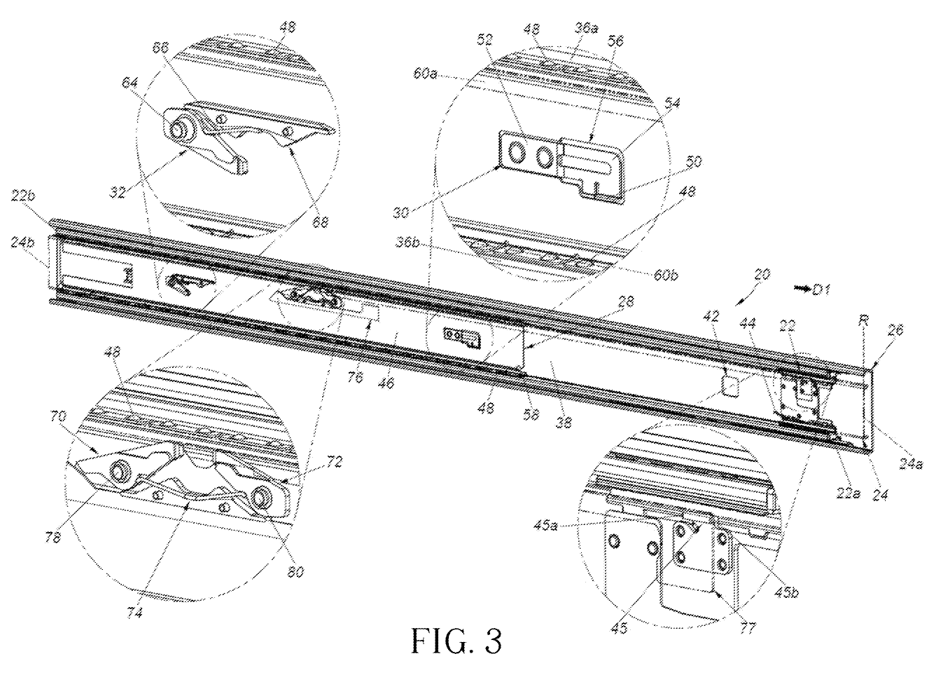

When the slide rail assembly 20 is in a retracted state as shown in FIG. 3, the second rail 24 is located at a retracted position R relative to the first rail 22 and the third rail 26, and the auxiliary member 32 and the second predetermined feature 50 of the resilient member 30 are spaced apart from each other by a longitudinal distance.

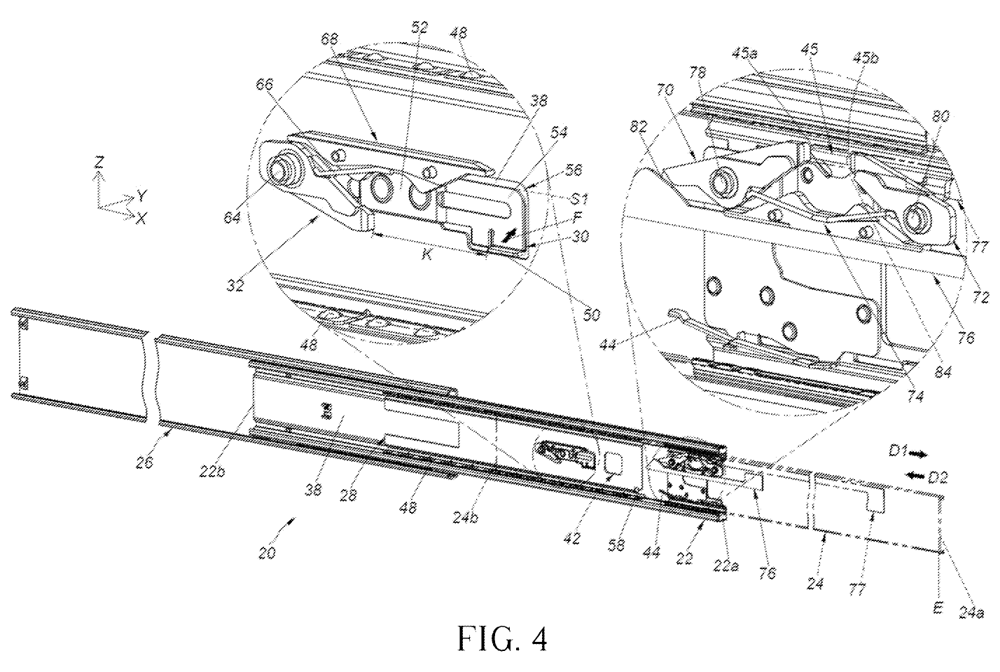

During a process that the second rail 24 is displaced relative to the first rail 22 from the retracted position R as shown in FIG. 3 to an extended position E as shown in FIG. 4 in an opening direction D1, the auxiliary member 32 and the second predetermined feature 50 of the resilient member 30 are still spaced apart from each other and do not contact with each other. Preferably, as shown in FIG. 4, when the second rail 24 is located at the extended position E relative to the first rail 22, the auxiliary member 32 and the second predetermined feature 50 of the resilient member 30 are spaced apart from each other by a predetermined longitudinal distance K. In this embodiment, by way of example, as shown in FIG. 4, the extended position E can be a fully extended position, and the slide rail assembly 20 can be in a fully extended state when the second rail 24 is located at the extended position E. Furthermore, the resilient portion 54 of the resilient member 30 is configured to pass through the predetermined through hole 56 to abut against the longitudinal wall 38 of the first rail 22, thereby remaining in a first state S1 where the resilient portion 54 of the resilient member 30 accumulates a resilient force F toward the longitudinal wall 38 of the first rail 22. Besides, as shown in FIG. 3 and FIG. 4, during the process that the second rail 24 is displaced relative to the first rail 22 from the retracted position R to the extended position E in the opening direction D1, the auxiliary member 32 and the second predetermined feature 50 on the resilient portion 54 of the resilient member 30 are corresponding to or aligned with each other in the longitudinal direction.

Furthermore, during the process that the second rail 24 is displaced relative to the first rail 22 from the retracted position R as shown in FIG. 3 to the extended position E as shown in FIG. 4, the auxiliary member 32 and the second predetermined feature 50 of the resilient member 30 are configured not to contact with each other. As a result, the auxiliary member 32 does not forcibly drive the aid-sliding device 28 to move in the opening direction D1, thereby preventing the engaging feature 58 of the aid-sliding device 28 from engaging with the predetermined structure 44 on the first rail 22 to ensure a smooth displacement of the second rail 24 between the extended position E and the retracted position R in either the opening direction D1 or a retracting direction D2. In other words, the present embodiment prevents a frictional displacement of the second rail 24 relative to the aid-sliding device 28, which is rendered immovable due to an engagement of the aid-sliding device 28 and the predetermined structure 44 on the first rail 22.

Preferably, when the second rail 24 is located at the extended position E relative to the first rail 22, the first working member 70 and the second working member 72 block the first end 45a and the second end 45b of the blocking portion 45, thereby preventing the second rail 24 from displacing away from the extended position E in either the opening direction D1 or the retracting direction D2.

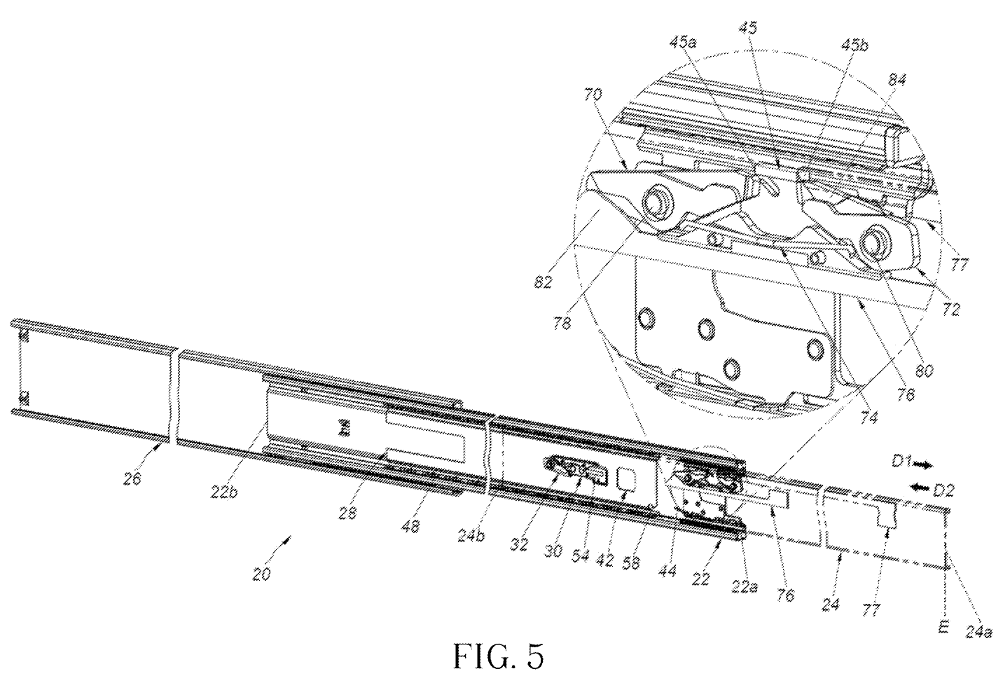

As shown in FIG. 4 and FIG. 5, a user can manipulate the first releasing member 76 to operate the first working member 70 so as to allow the second rail 24 to displace in the opening direction D1, and/or manipulate the second releasing member 77 to operate the second working member 72 so as to allow the second rail 24 to displace in the retracting direction D2. In this embodiment, by way of example, the first releasing member 76 and the second releasing member 77 can include a first driving portion 82 and a second driving portion 84 configured to drive the first working member 70 and the second working member 72 to pivot from an initial state as shown in FIG. 4 to a disengaged state as shown in FIG. 5 by an pivoting angle, thereby respectively preventing the first working member 70 and the second working member 72 from blocking the first end 45a and the second end 45b of the blocking portion 45 for allowing the second rail 24 to be displaced relative to the first rail 22 from the extended position E in the opening direction D1 or in the retracting direction D2, when the user manipulates the first releasing member 76 and the second releasing member 77. Besides, when the user manipulates the first releasing member 76 and the second releasing member 77 to operate the first working member 70 and the second working member 72, the resilient structure 74 accumulates an auxiliary resilient force in a deformed state. Accordingly, when the first releasing member 76 and the second releasing member 77 are released, the first working member 70 and the second working member 72 can return to the initial state in response to the auxiliary resilient force provided by the resilient structure 74.

As shown in FIG. 5 to FIG. 7, after the first working member 70 is operated to the disengaged state, the second rail 24 can be displaced relative to the first rail 22 from the extended position E in the opening direction D1 for a detachment of the second rail 24 from the channel 40 of the first rail 22.

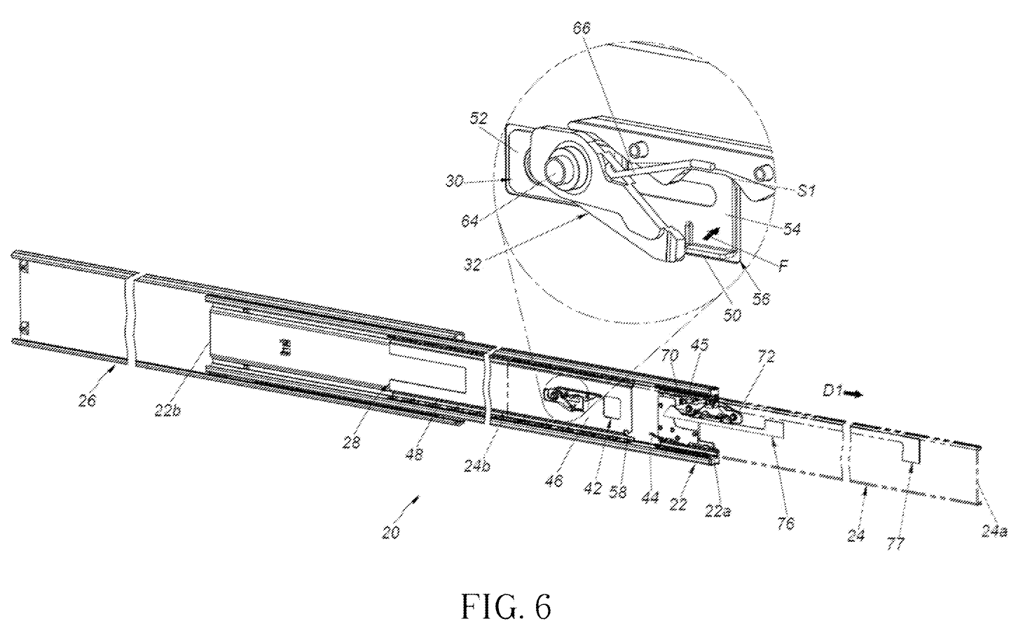

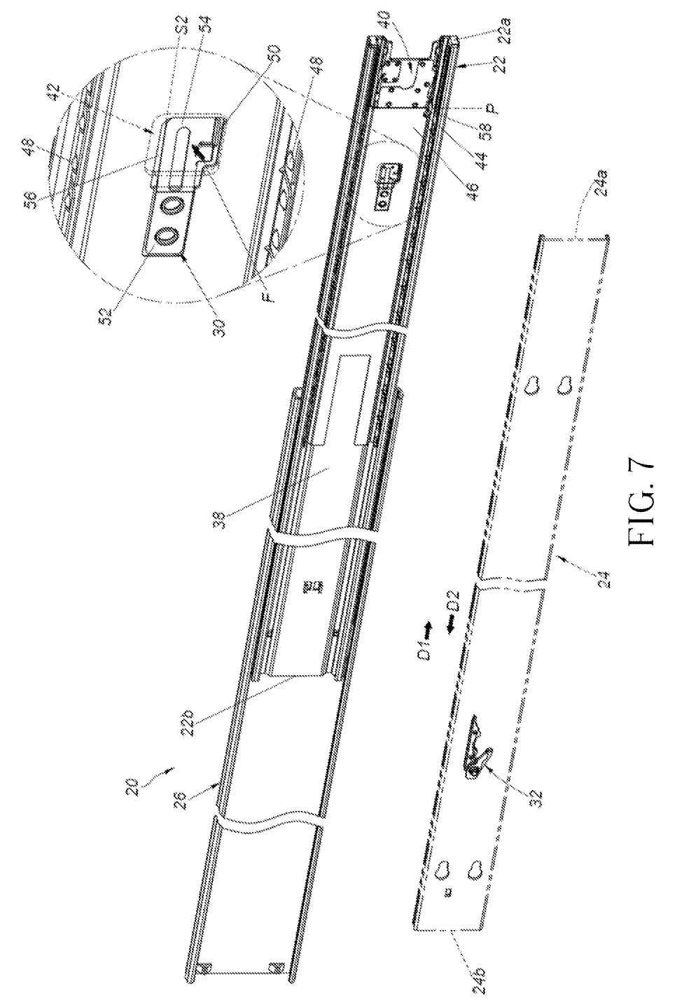

Furthermore, as shown in FIG. 6 and FIG. 7, during a process that the second rail 24 is displaced relative to the first rail 22 from the extended position E in the opening direction D1 for the detachment of the second rail 24 from the channel 40 of the first rail 22, the auxiliary member 32 is configured to contact with the second predetermined feature 50 on the resilient portion 54 of the resilient member 30 to forcibly drive the aid-sliding device 28 to move to a predetermined position P in the opening direction D1.

Preferably, when the aid-sliding device 28 is located at the predetermined position P, the engaging feature 58 of the main body 46 of the aid-sliding device 28 is configured to engage with a predetermined portion of the predetermined structure 44, thereby retaining the aid-sliding device 28 at the predetermined position P.

Preferably, when the aid-sliding device 28 is located at the predetermined position P, the second predetermined feature 50 on the resilient portion 54 of the resilient member 30 is located at a position corresponding to or aligned with the first predetermined feature 42 of the first rail 22 in the transverse direction or the lateral direction, such that the resilient portion 54 of the resilient member 30 releases the resilient force F to resiliently switch the resilient member 30 from the first state S1 to a second state S2, e.g., by swinging laterally or transversely, thereby preventing the auxiliary member 32 from contacting with the second predetermined feature 50 to allow the detachment of the second rail 24 in the opening direction D1, as shown in FIG. 7. In other words, when the aid-sliding device 28 is located at the predetermined position P, the second predetermined feature 50 of the resilient member 30 moves in the transverse direction to misalign with the auxiliary member 32 in the longitudinal direction in response to the resilient force F of the resilient portion 54 of the resilient member 30, thereby preventing the auxiliary member 32 and the second predetermined feature 50 of the resilient member 30 from contacting with each other to allow the detachment of the second rail 24 from the channel 40 of the first rail 22.

From the above, the slide rail assembly 20 includes the following characteristics.

1. During the process that the second rail 24 is displaced relative to the first rail 22 to the extended position E in the opening direction D1, the auxiliary member 32 is configured not to contact with the second predetermined feature 50 of the resilient member 30, thereby preventing the auxiliary member 32 from forcibly driving the aid-sliding device 28 in the opening direction D1 to prevent the engaging feature 58 of the aid-sliding device 28 from engaging with the predetermined structure 44 on the first rail 22 to ensure the smooth displacement of the second rail 24 between the extended position E and the retracted position R in either the opening direction D1 or the retracting direction D2.

2. During the process that the second rail 24 is displaced relative to the first rail 22 from the extended position E in the opening direction D1 for the detachment of the second rail 24 from the channel 40 of the first rail 22, the auxiliary member 32 is configured to contact with the second predetermined feature 50 of the resilient member 30 to forcibly drive the aid-sliding device 28 to move to the predetermined position P in the opening direction D1 to engage the engaging feature 58 of the main body 46 of the aid-sliding device 28 with the predetermined portion of the predetermined structure 44, thereby retaining the aid-sliding device 28 at the predetermined position P. Accordingly, when the second rail 24 is reinserted into the channel 40 of the first rail 22 in the retracting direction D2 from outside after the detachment of the second rail 24 from the channel 40 of the first rail 22, the aid-sliding device 28 at the predetermined position P can provide adequate support for a predetermined section of the second rail 24 adjacent to the second end 24b of the second rail 24, e.g., a rear rail section of the second rail 24, with the rolling members 48, thereby ensuring a smooth insertion of the second rail 24 into the channel 40 of the first rail 22.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A slide rail assembly comprising:
a first rail, a predetermined structure being arranged on the first rail;
a second rail displaceable relative to the first rail;
an aid-sliding device movably mounted between the first rail and the second rail;
a resilient member arranged on the aid-sliding device, the resilient member comprising a predetermined feature; and
an auxiliary member arranged on the second rail;
wherein during a process that the second rail is displaced relative to the first rail to an extended position in an opening direction, the auxiliary member does not contact with the predetermined feature of the resilient member;
wherein during a process that the second rail is displaced relative to the first rail from the extended position in the opening direction for a detachment of the second rail in the opening direction, the auxiliary member contacts with the predetermined feature of the resilient member to drive the aid-sliding device in the opening direction to reach a predetermined position where the aid-sliding device engages with the predetermined structure.

2. The slide rail assembly of claim 1, wherein the resilient member is switchable between a first state and a second state, the resilient member accumulates a resilient force when the resilient member is in the first state, another predetermined feature is further arranged on the first rail, and when the aid-sliding device is located at the predetermined position, the predetermined feature of the resilient member is located at a position corresponding to the another predetermined feature, such that the resilient member releases the resilient force to resiliently switch the resilient member from the first state to the second state in order to prevent the auxiliary member from contacting with the predetermined feature of the resilient member for allowing the detachment of the second rail in the opening direction.

3. The slide rail assembly of claim 2, wherein the aid-sliding device comprises a main body and a plurality of rolling members arranged on the main body and configured to contact with the first rail and the second rail.

4. The slide rail assembly of claim 3, wherein the predetermined structure is a resilient arm, and an engaging feature is arranged on the main body and configured to engage with the predetermined structure.

5. The slide rail assembly of claim 3, wherein the resilient member comprises a connecting portion and a resilient portion, the connecting portion is connected to the main body of the aid-sliding device, the resilient portion extends from the connecting portion, and the predetermined feature is arranged on the resilient portion.

6. The slide rail assembly of claim 5, wherein the another predetermined feature is a space defined by a plurality of walls, and when the aid-sliding device is located at the predetermined position, the predetermined feature on the resilient portion of the resilient member is located at the position corresponding to the another predetermined feature, such that the resilient portion of the resilient member releases the resilient force to resiliently switch the resilient member from the first state to the second state in order to prevent the auxiliary member from contacting with the predetermined feature of the resilient member.

7. The slide rail assembly of claim 2, wherein when the aid-sliding device is located at the predetermined position, the predetermined feature of the resilient member moves in a transverse direction to misalign with the auxiliary member in a longitudinal direction in response to the resilient force of the resilient member, thereby preventing the auxiliary member and the predetermined feature of the resilient member from contacting with each other.

8. The slide rail assembly of claim 1, wherein the auxiliary member is pivotally connected to the second rail, and the slide rail assembly further comprises a resilient feature configured to provide a predetermined resilient force to the auxiliary member.

9. The slide rail assembly of claim 1, wherein a blocking portion is further arranged on the first rail, and the slide rail assembly further comprises a first working member and a second working member, the first working member and the second working member are movably mounted on the second rail, and when the second rail is located at the extended position relative to the first rail, the first working member and the second working member block two ends of the blocking portion, respectively, for preventing the second rail from displacing away from the extended position.

10. The slide rail assembly of claim 9, wherein the first working member and the second working member are pivotally connected to the second rail, and the slide rail assembly further comprises at least one resilient structure configured to provide resilient forces to the first working member and the second working member.

11. The slide rail assembly of claim 10, further comprising a first releasing member configured to operate the first working member to prevent the first working member from blocking the blocking portion for allowing the second rail to displace away from the extended position in the opening direction.

12. The slide rail assembly of claim 1, wherein during the process that the second rail is displaced relative to the first rail to the extended position in the opening direction, the auxiliary member is aligned with the predetermined feature of the resilient member in a longitudinal direction.

13. A slide rail assembly comprising:
a first rail comprising a channel, a first predetermined feature and a blocking portion being located inside the channel;
a second rail displaceable relative to the first rail;
an aid-sliding device movably mounted between the first rail and the second rail;
a resilient member arranged on the aid-sliding device, the resilient member comprising a second predetermined feature;
an auxiliary member arranged on the second rail;
a first working member movably mounted on the second rail; and
a first releasing member;
wherein when the second rail is located at an extended position relative to the first rail, the first working member blocks an end of the blocking portion for preventing the second rail from displacing away from the extended position in an opening direction;
wherein the first releasing member is configured to operate the first working member to prevent the first working member from blocking the end of the blocking portion for allowing the second rail to displace away from the extended position in the opening direction;
wherein during a process that the second rail is displaced relative to the first rail away from the extended position in the opening direction for a detachment of the second rail from the channel of the first rail in the opening direction, the auxiliary member contacts with the second predetermined feature of the resilient member to drive the aid-sliding device in the opening direction to reach a predetermined position;
wherein the resilient member is switchable between a first state and a second state, the resilient member accumulates a resilient force when the resilient member is in the first state, when the aid-sliding device is located at the predetermined position, the second predetermined feature of the resilient member is located at a position corresponding to the first predetermined feature, such that the resilient member releases a resilient force to resiliently switch the resilient member from the first state to the second state in order to prevent the auxiliary member from contacting with the second predetermined feature of the resilient member for allowing the detachment of the second rail from the channel of the first rail in the opening direction.

14. The slide rail assembly of claim 13, wherein the aid-sliding device comprises a main body and a plurality of rolling members arranged on the main body and configured to contact with the first rail and the second rail.

15. The slide rail assembly of claim 14, wherein the resilient member comprises a connecting portion and a resilient portion, the connecting portion is connected to the main body of the aid-sliding device, the resilient portion extends from the connecting portion, and the second predetermined feature is arranged on the resilient portion.

16. The slide rail assembly of claim 15, wherein the first predetermined feature is a space defined by a plurality of walls, and when the aid-sliding device is located at the predetermined position, the second predetermined feature on the resilient portion of the resilient member is located at the position corresponding to the first predetermined feature, such that the resilient member releases the resilient force to resiliently switch the resilient member from the first state to the second state in order to prevent the auxiliary member from contacting with the second predetermined feature of the resilient member.

17. The slide rail assembly of claim 13, wherein the first rail comprises a first end and a second end opposite to the first end, and the blocking portion is located adjacent to the first end of the first rail.

18. The slide rail assembly of claim 13, wherein when the aid-sliding device is located at the predetermined position, the second predetermined feature of the resilient member moves in a transverse direction to misalign with the auxiliary member in a longitudinal direction in response to the resilient force of the resilient member, thereby preventing the auxiliary member and the second predetermined feature of the resilient member from contacting with each other.

19. The slide rail assembly of claim 13, wherein the auxiliary member is pivotally connected to the second rail, and the slide rail assembly further comprises a resilient feature configured to provide a predetermined resilient force to the auxiliary member.

20. The slide rail assembly of claim 13, wherein during a process that the second rail is displaced relative to the first rail to the extended position in the opening direction, the auxiliary member does not contact with the second predetermined feature of the resilient member and is aligned with the second predetermined feature of the resilient member in a longitudinal direction.
